(19) United States
(12) Patent Application Publication
(10) Pub. No.: US 2024/0001700 A1
(43) Pub. Date: Jan. 4, 2024

(54) FORMING OPTICAL DEVICE USING MIXED-PARTICLE LAYER

(71) Applicant: Applied Materials, Inc., Santa Clara, CA (US)

(72) Inventors: Yingdong LUO, Newark, CA (US); Xiaopei DENG, San Jose, CA (US); Rami HOURANI, Santa Clara, CA (US); Ludovic GODET, Sunnyvale, CA (US)

(21) Appl. No.: 18/337,294

(22) Filed: Jun. 19, 2023

Related U.S. Application Data
(60) Provisional application No. 63/358,011, filed on Jul. 1, 2022.

(51) Int. Cl. B41M 3/00; G02B 27/01; B41J 11/00; B41M 5/00

(52) U.S. Cl. CPC B41M 3/003; G02B 27/0172; B41J 11/0021; B41M 5/0047; G02B 2207/101

(57) ABSTRACT

A method of forming an optical device is provided. The method includes forming a first layer over a plurality of optical structures, the first layer including a first plurality of nanoparticles and a second plurality of nanoparticles. The first plurality of nanoparticles and the second plurality of nanoparticles are formed of a first material, the first plurality of nanoparticles have a first average volume, greater than 95% of the first plurality of nanoparticles have a volume within 10% of the first average volume, the second plurality of nanoparticles have a second average volume, greater than 95% of the second plurality of nanoparticles have a volume within 10% of the second average volume, and the second average volume is at least 25% larger the first average volume.

### CROSS-REFERENCE TO RELATED APPLICATIONS

This application claims the benefit of U.S. Provisional Patent Application No. 63/358,011, filed on Jul. 1, 2022. The contents of this provisional patent application is herein incorporated by reference.

### BACKGROUND

Embodiments of the present disclosure generally relate to optical devices including a mixed-particle layer and methods for forming optical devices using a mixed-particle layer.

### DESCRIPTION OF THE RELATED ART

Virtual reality is generally considered to be a computer generated simulated environment in which a user has an apparent physical presence. A virtual reality experience can be generated in 3D and viewed with a head-mounted display (HMD), such as glasses or other wearable display devices that have near-eye display panels as lenses to display a virtual reality environment that replaces an actual environment.

Augmented reality, however, enables an experience in which a user can still see through the display lenses of the glasses or other HMD device to view the surrounding environment, yet also see images of virtual objects that are generated to appear as part of the environment. Augmented reality can include any type of input, such as audio and haptic inputs, as well as virtual images, graphics, and video that enhances or augments the environment that the user experiences. As an emerging technology, there are many challenges and design constraints with augmented reality.

One such challenge is displaying a virtual image overlaid on an ambient environment. Optical devices including waveguide combiners, such as augmented reality waveguide combiners, and flat optical devices, such as metasurfaces, are used to assist in overlaying images. Generated light is propagated through an optical device until the light exits the optical device and is overlaid on the ambient environment. Optical loss during propagation of the light inside the optical device remains a problem. Furthermore, it can often be beneficial for optical performance to use materials having a high refractive index (e.g., a refractive index>2.0), but an increase of the refractive index often comes with an increase in optical loss.

Accordingly, what is needed in the art are optical devices that can deliver the intended optical performance with high-refractive index materials without significant amounts of optical loss and methods for forming these optical devices.

### SUMMARY

In one embodiment, a method of forming an optical device is provided. The method includes forming a first layer over a plurality of optical structures, the first layer including a first plurality of nanoparticles and a second plurality of nanoparticles, wherein the first plurality of nanoparticles have a first average volume, greater than 95% of the first plurality of nanoparticles have a volume within 10% of the first average volume, the second plurality of nanoparticles have a second average volume, greater than 95% of the second plurality of nanoparticles have a volume within 10% of the second average volume, and the second average volume is at least 25% larger the first average volume.

In another embodiment, a method of forming an optical device is provided. The method includes forming a first layer over a plurality of optical structures, the first layer including a first plurality of nanoparticles and a second plurality of nanoparticles, wherein the first plurality of nanoparticles are formed of a first material and the second plurality of nanoparticles are formed of a second material, and the first plurality of nanoparticles and the second plurality of nanoparticles comprise greater than 95% of optically transparent nanoparticles in the first layer.

In another embodiment, a method of forming an optical device is provided. The method includes forming a first layer over a plurality of optical structures, the first layer including a first plurality of nanoparticles and a second plurality of nanoparticles, the first plurality of nanoparticles have a different geometry than the second plurality of nanoparticles, and the first plurality of nanoparticles and the second plurality of nanoparticles comprise greater than 95% of optically transparent nanoparticles in the first layer.

### BRIEF DESCRIPTION OF THE DRAWINGS

So that the manner in which the above recited features of the present disclosure can be understood in detail, a more particular description of the disclosure, briefly summarized above, may be had by reference to embodiments, some of which are illustrated in the appended drawings. It is to be noted, however, that the appended drawings illustrate only exemplary embodiments and are therefore not to be considered limiting of its scope, and may admit to other equally effective embodiments.

FIG. 1A is a schematic, cross-sectional view of an optical device, according to one embodiment.

FIG. 1B is a schematic, cross-sectional view of an optical device, according to one embodiment.

FIG. 1C is a schematic, cross-sectional view of an optical device, according to one embodiment.

FIG. 2 is a process flow diagram of a method of forming the optical devices shown in FIGS. 1A-1C, according to one embodiment.

FIG. 3A is a schematic, cross-sectional view of an optical device, according to one embodiment.

FIG. 3B is a schematic, cross-sectional view of an intermediate device, according to one embodiment.

FIG. 3C is a schematic, cross-sectional view of an imprinting process being performed on the intermediate device of FIG. 3B, according to one embodiment.

To facilitate understanding, identical reference numerals have been used, where possible, to designate identical elements that are common to the figures. It is contemplated that elements and features of one embodiment may be beneficially incorporated in other embodiments without further recitation.

### DETAILED DESCRIPTION

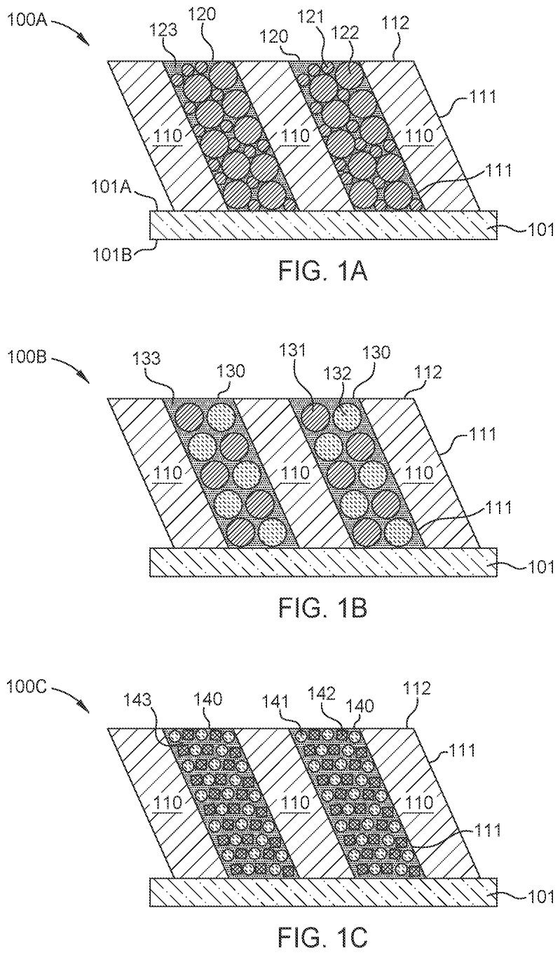

Embodiments of the present disclosure generally relate to optical devices. More specifically, embodiments described herein relate to optical devices with high levels of optical performance and reduced levels of optical loss compared to conventional optical devices as wells as methods for forming these optical devices. The high levels of optical performance coupled with the low levels of optical loss are obtained by using one or more mixed-particle layers, such as layers having two or more different types of nanoparticles, as described in fuller detail below. Some exemplary different types of nanoparticles used in the mixed-particle layers can include particles of different sizes (see FIG. 1A), particles of different materials (see FIG. 1B), and particles of different geometries (see FIG. 1C).

FIG. 1A is a schematic, cross-sectional view of an optical device 100A, according to one embodiment. The optical device 100A includes nanoparticles of different sizes to improve the optical performance. Unless specifically noted otherwise, the following description of the optical device 100A is also applicable to the optical device 100B (FIG. 1B) and the optical device 100C (FIG. 1C). In one embodiment, which can be combined with other embodiments described herein, the optical device 100A is a waveguide combiner, such as an augmented reality waveguide combiner. In another embodiment, which can be combined with other embodiments described herein, the optical device 100A is a flat optical device, such as a metasurface. Other optical devices that can be formed from the optical device 100A include optical filters and dielectric mirrors.

The optical device 100A includes an optical device substrate 101, a plurality of optical device structures 110, and an optical coating 120 (also referred to as first layer) disposed over the optical device structures 110 and the substrate 101. The optical coating 120 includes particles 121, 122 of different sizes as described in fuller detail below. In some embodiments, the optical coating 120 can contact the optical device structures. Used herein, with respect to coatings and layers, “over” refers to a coating or layer that is adjacent to another component without any relation to the relative vertical positioning of the coating and the other component. The optical coating 120 can include particles (e.g., optical nanoparticles) that can help improve the optical performance of the optical device 100A.

In one embodiment, the optical device structures 110 are gratings of a waveguide combiner. The optical device substrate 101 includes a first surface 101A and an opposing second surface 101B. The optical device structures 110 are disposed over the first surface 101A of the optical device substrate 101. In some embodiments, the optical device structures 110 are disposed directly on the first surface 101A of the substrate 101.

The substrate 101 can be formed of any suitable material, provided that the substrate 101 can adequately transmit light of a specified wavelength or wavelength range and can serve as an adequate support for one or more optical devices formed on the substrate 101.

In some embodiments, the substrate 101 can be formed of materials including, but not limited to, silicon carbide, amorphous dielectrics, crystalline dielectrics, silicon, silicon oxide, silicon carbide, silica (e.g., fused silica), sapphire, glass, magnesium oxide, diamond, lanthanum oxide, titanium oxide (e.g., TiO₂), tantalum oxide one or more polymers, oxide materials, nitride materials, sulfide materials, phosphide materials, telluride materials, or combinations thereof. In some embodiments, which can be combined with other embodiments described herein, the substrate 101 includes an optically transparent material. Furthermore, in some embodiments, a layer (not shown) can be disposed on the substrate 101. The layer can be formed of a material that is more suitable for forming a pattern than the material of the substrate 101. The layer can be formed from a variety of materials, such as silicon nitride (SiN), titanium oxide (TiO₂), silicon oxide (SiO₂), niobium oxide (Nb₂O₅), chromium, amorphous silicon or more than one material (e.g., TiO₂/SiO₂). In some embodiments, this layer can be used to form the optical device structures 110 or another feature on the optical device.

Each optical device structure 110 can include a top surface 112 and a pair of sidewalls 111. In some embodiments, the plurality of optical device structures 110 can be spaced apart from each other in a direction parallel to the first surface 101A of the substrate 101. The optical device structures 110 include sub-micron critical dimensions, e.g., nanosized dimensions, corresponding to the widths of the optical device structures 110 that extend in the same direction in which the optical device structures 110 are spaced apart. In some embodiments, the optical device structures 110 may be binary structures (not shown) with sidewalls 111 perpendicular to the first surface 101A of the substrate 101. In other embodiments, the optical device structures 110 may be angled structures, for example as shown in FIG. 1A, with at least one of the sidewalls 111 angled relative to the first surface 101A of the substrate 101.

The optical device structures 110 can be formed of an optically transparent material, such as any of the materials described below for the particles 121, 122. In one embodiment, the optical device structures 110 can be formed of a metal oxide (e.g., titanium oxide). In another embodiment, the optical device structures 110 can be formed of a stack of different layers, such as a stack of metal oxides (e.g., silicon oxide and titanium oxide).

The optical coating 120 is disposed over the optical device structures 110. In some embodiments, the optical coating 120 can fill the entire gap between neighboring optical device structures 110, for example as shown in FIG. 1A. In other embodiments, a gap can remain after the optical coating 120 is applied over portions of the sidewalls 111 of the optical device structures 110. Furthermore, in some embodiments the optical coating can be applied over the top surface 112 of the optical device structures 110 as well as in the gap between the optical device structures 110.

The optical coating 120 includes a first plurality of particles 121, a second plurality of particles 122, and a binder 123. The particles 121, 122 can be substantially uniformly dispersed throughout the binder 123. The particles 121, 122 can be referred to as nanoparticles. In some embodiments, the particles 121, 122 can have dimensions, such as a diameter for a roughly spherical nanoparticle from about 0.1 nm to about 1000 nm, such as from about 0.5 nm to about 500 nm, such as from about 1 nm to about 50 nm.

The binder 123 can include a curing agent that is configured to be cured thermally, from radiation (e.g., an ultraviolet cure), and/or from a chemical process. In some embodiments, the binder 123 can be formed of an organic binder. Some examples of materials that can be used for the binder 123 include an epoxy, thiol, silicone, acrylate, or methacrylate-based binder.

The first plurality of particles 121 and the second plurality of particles 122 can be formed of a variety of materials. In some embodiments, the particles 121, 122 can be formed of a metal oxide, such as silicon oxide (SiO₂), titanium oxide (TiO₂), zirconium oxide (ZrO₂), niobium oxide (Nb₂O₅), hafnium oxide (HfO₂), vanadium oxide (V₂O₅), lead oxide (PbO₂), tantalum oxide (Ta₂O₅), zinc oxide (ZnO), tin oxide (SnO₂), aluminum oxide (Al₂O₃), silver oxide (AgO, Ag₂O), or lithium oxide (Li₂O). In other embodiments, the particles 121, 122 can be formed of a metal sulfide, such as cadmium sulfide (CdS), zinc sulfide (ZnS), tungsten (WS₂), copper sulfide (CuS), bismuth sulfide (Bi₂S₃), or antimony sulfide (Sb₂S₃). In other embodiments, the particles 121, 122 can be formed of a metal selenide, such as cadmium selenide (CdSe) or mercury selenide (HgSe) or a metal telluride, such as cadmium telluride (CdTe). In other embodiments, the particles 121, 122 can be formed of a nitride, such as gallium nitride (GaN) or a phosphide, such as indium phosphide (InP) or gallium phosphide (GaP). In other embodiments, the particles 121, 122 can be formed of an element, such as silver, gold, copper, or silicon. In still other embodiments, the particles 121, 122 can be formed of a perovskite material. In some embodiments, the particles 121, 122 can have a structure that includes multiple materials. For example, in one embodiment, the particles 121, 122 can have a structure with a shell of one material (e.g., SiO₂ or ZnS) surrounding a core of another material (e.g., TiO₂ or InP).

Additionally, in some embodiments the particles 121, 122 can include one or more organic ligands (e.g., a fatty acid or polyester ligand) to increase solubility of the particles 121, 122 in the binder 123 and allow for the particles 121, 122 to be more uniformly dispersed throughout the binder 123. Some additional examples of ligands can include ligand can be or include one or more carboxylic acids, one or more esters, one or more amines, one or more alcohols, one or more silanes, salts thereof, complexes thereof, or any combination thereof, oleic acid, stearic acid, propionic acid, benzoic acid, palmitic acid, myristic acid, methylamine, oleylamine, butylamine, benzyl alcohol, oleyl alcohol, butanol, octanol, dodecanol, octyltrimethoxy silane, octyltriethoxy silane, octenyltrimethoxy silane, octenyltri ethoxy silane, 3-trimethoxysilyl) propyl methacrylate, pro pyltriethoxy silane, salts thereof, esters thereof, complexes thereof, or any combination thereof. The ligands as well as the mixture of different sized particles can effect the viscosity of the coating 120 during application of the coating 120. For example, a greater amount of smaller particles can lead to higher ligand loading, which can increase the viscosity.

In some embodiments, the particles 121, 122 can be formed of the same material. In other embodiments, the particles 121, 122 can be formed of different materials, for example as described below in reference to FIG. 1B. Additionally, in some embodiments, the particles 121, 122 can also have different geometries (e.g., a different crystal phase) but have a same composition (e.g., titanium oxide), for example as described below in reference to FIG. 1C. Furthermore, although only two particles 121, 122 are shown in FIG. 1A, other embodiments can include three or more different particles. Additionally, each of the particles can have different sizes, be formed of different materials, and/or have different geometries relative to the other particles in the optical coating 120.

Each particle in the second plurality of particles 122 can be substantially larger than each particle in the first plurality of particles 121. For example, the average volume for a particle in the second plurality of particles 122 is at least 10% larger, 25% larger, 50% larger, two times larger, five times larger, or ten times larger than the average volume for a particle in the first plurality of particles 121. Larger particles can generally have a higher refractive index, but can also cause more optical loss due to light scattering, which reduces optical performance. On the other hand, smaller particles cause less optical loss due to light scattering, but the refractive index is often lower.

In some embodiments, the first plurality of particles 121 and the second plurality of particles 122 can comprise greater than 95%, such as greater than 99% of all of the optically transparent nanoparticles of the material(s) in the optical coating 120 that form the first plurality of particles 121 and the second plurality of particles 122.

Each of the first plurality of particles 121 and the second plurality of particles 122 accounts for a significant portion of the total amount of the particles 121, 122. For example, in many embodiments each of the plurality of particles 121, 122 accounts for at least 5%, at least 10% or at least 25% of the total amount of particles 121, 122. In some embodiments, greater than 95%, such as greater than 99% of the particles in the first plurality of particles 121 have a volume that is within 10%, 5%, or 1% of the average volume for the first plurality of particles 121. Similarly, in some embodiments, greater than 95%, such as greater than 99% of the particles in the second plurality of particles 122 have a volume that is within 10%, 5%, or 1% of the average volume for the second plurality of particles 122. Furthermore, in these embodiments, the first plurality of particles 121 and the second plurality of particles 122 can comprise greater than 95%, such as greater than 99% of all of the nanoparticles of the material in the optical coating 120 that forms the first plurality of particles 121 and the second plurality of particles 122. Thus, in these embodiments the sizes of the particles 121, 122 do not overlap with each other except for potentially very small percentages (e.g., <1%). Having these high percentages of the nanoparticles be confined to these relatively narrow size ranges can be used to increase the packing density of the nanoparticles in the optical coating 120 because the smaller particles can fit inside voids between larger particles that would otherwise only include binder if only larger particles were included.

Increasing the particle density of layers including these optical nanoparticles can help improve the optical performance of the optical device 100A by having more of the light passing through the coating 120 interact with an optical nanoparticle or more nanoparticles, such as particles 121, 122, as opposed to interacting only with the binder 123 or with less nanoparticles. This increased interaction can be useful when light is outcoupled from an optical device, such as when light is outcoupled from a waveguide combiner for use in an augmented reality application.

FIG. 1B is a schematic, cross-sectional view of an optical device 100B, according to one embodiment. The optical device 100B includes nanoparticles of different materials to improve optical performance. The optical device 100B is the same as the optical device 100A described above except that the optical device 100B includes an optical coating 130 instead of the optical coating 120 that is included in the optical device 100A. The optical coating 130 includes a first plurality of particles 131, a second plurality of particles 132, and a binder 133. In some embodiments, the binder 133 is the same as the binder 123 described above.

Each of the first plurality of particles 131 and the second plurality of particles 132 accounts for a significant portion of the total amount of the particles 131, 132. For example, in many embodiments each of the plurality of particles 131, 132 accounts for at least 5%, at least 10% or at least 25% of the total amount of particles 131, 132. The first plurality of particles 131 and the second plurality of particles 132 can comprise greater than 95%, such as greater than 99% of all of the optically transparent nanoparticles of the materials in the optical coating 130 that form the first plurality of particles 131 and the second plurality of particles 132.

The particles 131, 132 can be formed from any of the materials described above for the particles 121, 122. The first plurality of particles 131 is formed of a different material than the second plurality of particles 132. In some embodiments, the chemical elements (i.e., elements on the Periodic Table of Elements) are the same in both particles and only the chemical composition is different, such as a first particle 131 of TiO₂ and a second particle 132 of Ti₂O₃. In other embodiments, at least one of the particles 131, 132 includes at least one chemical element not included in the other particle 131, 132, such as a first particle 131 of silver and a second particle 132 of silver oxide.

In other embodiments, no chemical elements are shared between the two particles 131, 132. Thus, in these embodiments the first particles 131 are formed of a first material consisting of one or more chemical elements, the second particles 132 are formed of a second material consisting of one or more chemical elements that are each different from the one or more chemical elements that form the first material. For example, in one embodiment the first plurality of particles 131 can be formed of titanium oxide and the second plurality of particles 132 can be formed of gallium nitride.

By including particles 131, 132 having different compositions, the optical coating 130 can formed to have optical properties (e.g., refractive index and optical loss) that would not be possible from an optical coating only having particles formed from a single material. Furthermore, although only two types of particles 131, 132 are shown, other embodiments can include three or more types of particles in which each type of particle is formed from a different material to enable the formation of optical coatings with a larger variety of optical properties.

FIG. 1C is a schematic, cross-sectional view of an optical device 100C, according to one embodiment. The optical device 100C includes nanoparticles of different geometries to improve the optical performance. The optical device 100C is the same as the optical device 100A described above except that the optical device 1008 includes an optical coating 140 instead of the optical coating 120 that is included in the optical device 100A. The optical coating 140 includes a first plurality of particles 141, a second plurality of particles 142, and a binder 143. In some embodiments, the binder 143 is the same as the binder 123 described above.

Each of the first plurality of particles 141 and the second plurality of particles 142 accounts for a significant portion of the total amount of the particles 141, 142. For example, in many embodiments each of the plurality of particles 141, 142 accounts for at least 5%, at least 10% or at least 25% of the total amount of particles 141, 142. Furthermore, the first plurality of particles 141 and the second plurality of particles 142 can comprise greater than 95%, such as greater than 99% of all of the nanoparticles of the materials in the optical coating 140 that form the first plurality of particles 141 and the second plurality of particles 142.

The particles 141, 142 can be formed from any of the materials described above for the particles 121, 122. The particles 141, 142 can be formed from a same material (e.g., titanium oxide) or different materials. The first plurality of particles 141 has a different geometry than the second plurality of particles 142. These different geometries can include (1) particles with structures having a different crystal phase, (2) one particle having a crystal structure compared to another particle having an amorphous structure, or (3) particles have different three-dimensional shapes. In one embodiment for particles with structures of a different crystal phase, the first plurality of particles 141 can be formed of titanium oxide having a rutile phase (first crystal phase) and the second plurality of particles 142 can be formed of titanium oxide having an anatase phase (second crystal phase). Some of the different three-dimensional shapes that the structures of the particles can have include, but are not limited to spherical, cubic, rod, pyramidal, hexagonal, tetragonal, rhombohedral, orthorhombic, monoclinic and triclinic. By including particles 141, 142 having different geometries, the optical coating 140 can formed to have optical properties (e.g., refractive index and optical loss) that would not be possible from an optical coating only having particles formed from a single material in which all of the particles have the same geometry. Furthermore, although only two types of particles 141, 142 are shown, other embodiments can include three or more types of particles in which each type of particle has a different geometry to enable the formation of optical coatings with a larger variety of optical properties. Using particles 141, 142 of different geometries can improve the optical performance of an optical device, for example by increasing the packing density of the optical particles in the coating as well as by forming a coating with a refractive index and optical loss characteristics that would not be obtainable if only one type of particle were used.

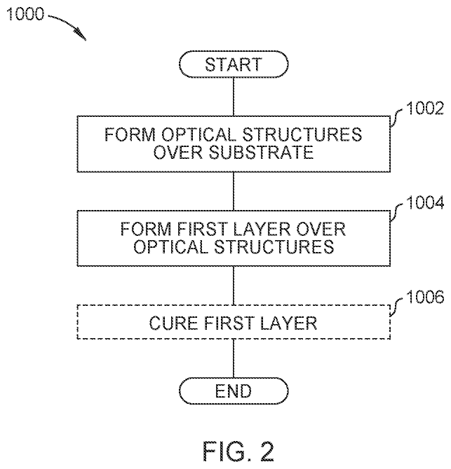

FIG. 2 is a process flow diagram of a method 1000 of forming the optical devices 100A, 100B, and 100C shown in FIGS. 1A-1C, according to one embodiment.

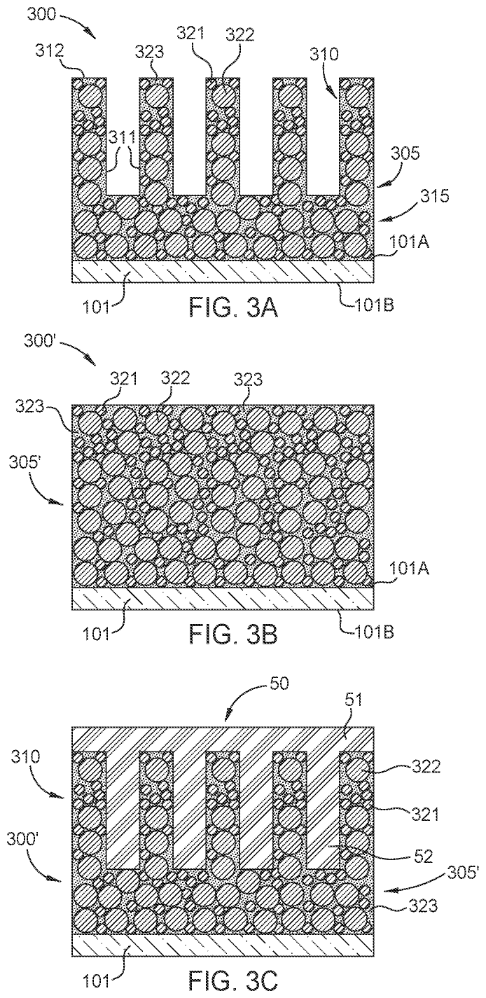

The method 1000 begins at block 1002. At block 1002, the plurality of optical structures 310 are formed over the substrate 101. In some embodiments, forming the optical device structures 110 can include a deposition (e.g., a physical vapor deposition or a chemical vapor deposition) followed by one or more etching and/or lithography processes to remove the material in between each of the neighboring optical device structures 110. In other embodiments, the optical device structures 110 can be formed by an imprinting process in which a material is imprinted with a stamp, and then the imprinted material is cured to form optical device structures 110. An example of an optical device formed from an imprinting process is described below in reference to FIGS. 3A-3C.

At block 1004, the optical coating (first layer) is formed over the optical structures 310. The optical coating formed at block 1004 can include the optical coating 120 (FIG. 1A), the optical coating 130 (FIG. 1B), or the optical coating 140 (FIG. 1C). Each of these optical coatings 12, 130, 140 can be formed using a variety of processes, such as a spin-coating process, an inkjet process, or a spray-coating process. Generally, a spin-coating or spray-coating process results in the optical coating also being formed over the top surfaces 112 of the optical structures 310. On the other hand, an inkjet process can be used when the optical coating is only provided in the gaps between the optical structures 310 without applying the optical coating on the top surfaces 112 of the optical structures 310, for example as shown in FIG. 1A.

For each of the coatings 120, 130, 140, the corresponding particles 121, 122 (FIG. 1A), 131, 132 (FIG. 1B), and 141, 142 (FIG. 1C) can be deposited simultaneously from a mixture that includes each of the corresponding particles and the binder, such as binder 123.

At block 1006, the optical coating formed at block 1004 can optionally be cured. Curing the optical coating 120 can maintain the position of the particles 121, 122 relative to the optical structures 310. Curing the optical coating can also cause the optical coating to have a consistent effect on the optical performance of the optical device 100A, 100B, 100C during the useful life of the optical device.

FIG. 3A is a schematic, cross-sectional view of an optical device 300, according to one embodiment. The optical device 300 includes an optical layer 305 formed over a first surface 101A of the substrate 101. The optical layer 305 includes optical structures 310 and a base 315. The substrate 101 can be the same substrate described above in reference to FIGS. 1A-1C. The optical device 300 is similar to the optical device 100A described above except that the optical device 300 includes the optical structures 310 instead of the optical structures 310, and the optical device does not include the optical coating 120. The optical structures 310 can be formed using an imprinting process using a stamp 50 as described below in reference to FIG. 3C.

Each of the optical structures 310 include sidewalls 311 and a top surface 312. In one embodiment, the optical structures 310 can be gratings of a waveguide combiner. Although the optical structures 310 are illustrated as having a different external structure than the optical structures 310, in some embodiments, the external structure of the optical structures 310 can be highly similar to the optical structures 310 described above. For example, in some embodiments the optical structures 310 can have the same or highly similar dimensions to the optical structures 310, such as height, width, angle relative to the substrate 101, and spacing between the individual optical structures 310.

The optical structures 310 can have a different internal structure relative to the optical structures 110 described above and can be formed by a different process. On the other hand, the optical structures 310 can have an internal structure that is similar to the optical coatings 120, 130, 140 described above. For example, the optical structures 310 can include a first plurality of particles 321, a second plurality of particles 322, and a binder 323. The first plurality of particles 321 and the second plurality of particles 322 can be uniformly distributed throughout the binder 323. The binder 323 can be formed of the same material as the binder 123 described above. Furthermore, the particles 321, 322 can include any pair of the particles described above for the plurality of particles 121, 122 (FIG. 1A), 131, 132 (FIG. 1B), or 141, 142 (FIG. 1C). Additionally, although only two particles 321, 322 are shown three or more different types of particles may be included.

FIG. 3B is a schematic, cross-sectional view of an intermediate device 300′, according to one embodiment. The intermediate device 300′ includes an optical layer 305′. The optical layer 305′ is the optical layer 305 before an imprinting process is performed on the optical layer 305′ to form the optical layer 305. The optical layer 305′ can be formed over the first surface 101A of the substrate 101 using a variety of processes, such as a spin-coating process, an inkjet process, or a spray-coating process.

FIG. 3C is a schematic, cross-sectional view of an imprinting process being performed on the intermediate device 300′, according to one embodiment. A stamp 50 is used to imprint a pattern on the optical layer 305′. The stamp 50 includes a base 51 and a plurality of patterned features 52. The plurality of patterned features 52 can be used to form the gaps between the plurality of optical structures 310 in the optical device 300. The gaps between the plurality of patterned features 52 can be used to form the plurality of optical structures 310.

After the optical layer 305′ is imprinted with the stamp 50, the optical layer 305′ can be cured to form the optical device 300 that includes optical layer 305 shown in FIG. 3A. In some embodiments, the optical layer 305′ can be cured after releasing the stamp 50 from the optical layer 305′. In other embodiments, the optical layer 305′ can be cured while the stamp 50 remains on the optical layer 305′. After the optical device 300 is formed, in some embodiments, one of the optical coatings 120, 130, 140 described above can be formed over the optical structures 310 in a similar manner as described above for forming the optical coatings 120, 130, 140 over the optical structures 110.

While the foregoing is directed to examples of the present disclosure, other and further examples of the disclosure may be devised without departing from the basic scope thereof, and the scope thereof is determined by the claims that follow.

What is claimed is:

1. A method of forming an optical device comprising:
forming a first layer over a plurality of optical structures, the first layer including a first plurality of nanoparticles and a second plurality of nanoparticles, wherein
the first plurality of nanoparticles have a first average volume,
greater than 95% of the first plurality of nanoparticles have a volume within 10% of the first average volume,
the second plurality of nanoparticles have a second average volume,
greater than 95% of the second plurality of nanoparticles have a volume within 10% of the second average volume, and
the second average volume is at least 25% larger the first average volume.

2. The method of claim 1, wherein
the first plurality of nanoparticles and the second plurality of nanoparticles are formed of a first material, and
the first plurality of nanoparticles and the second plurality of nanoparticles comprises greater than 95% of the total nanoparticles formed of the first material in the first layer.

3. The method of claim 1, wherein the first layer is formed by depositing a mixture that includes the first plurality of nanoparticles and the second plurality of nanoparticles.

4. The method of claim 1, wherein the second average volume is at least two times the first average volume.

5. The method of claim 1, wherein the second average volume is at least five times the first average volume.

6. The method of claim 1, wherein the first layer is formed using an inkjet process.

7. The method of claim 1, wherein the first plurality of nanoparticles and the second plurality of nanoparticles are formed an oxide.

8. A method of forming an optical device comprising:
forming a first layer over a plurality of optical structures, the first layer including a first plurality of nanoparticles and a second plurality of nanoparticles, wherein
the first plurality of nanoparticles are formed of a first material and the second plurality of nanoparticles are formed of a second material, and
the first plurality of nanoparticles and the second plurality of nanoparticles comprise greater than 95% of optically transparent nanoparticles in the first layer.

9. The method of claim 8, wherein
the first material and the second material are formed of a same one or more chemical elements, and
the first material has a different chemical composition than the second material.

10. The method of claim 8, wherein the second material includes at least one chemical element other than one or more chemical elements included in the first material.

11. The method of claim 8, wherein
the first material consists of one or more chemical elements, and
the second material consists of one or more chemical elements that are each different from the one or more chemical elements that form the first material.

12. The method of claim 8, wherein forming the first layer comprises curing a mixture that includes the first plurality of nanoparticles and the second plurality of nanoparticles after the mixture is deposited over the plurality of optical structures.

13. The method of claim 8, wherein the first layer is formed by depositing a mixture that includes the first plurality of nanoparticles and the second plurality of nanoparticles.

14. The method of claim 8, wherein the first layer is formed using an inkjet process.

15. A method of forming an optical device comprising:
forming a first layer over a plurality of optical structures, the first layer including a first plurality of nanoparticles and a second plurality of nanoparticles, wherein
the first plurality of nanoparticles have a different geometry than the second plurality of nanoparticles, and
the first plurality of nanoparticles and the second plurality of nanoparticles comprise greater than 95% of optically transparent nanoparticles in the first layer.

16. The method of claim 15, wherein forming the first layer comprises curing a mixture that includes the first plurality of nanoparticles and the second plurality of nanoparticles after the mixture is deposited over the plurality of optical structures.

17. The method of claim 15, wherein the first layer is formed by depositing a mixture that includes the first plurality of nanoparticles and the second plurality of nanoparticles.

18. The method of claim 15, wherein the first layer is formed using an inkjet process.

19. The method of claim 15, wherein
the first plurality of nanoparticles are formed of a rutile phase of titanium oxide, and
the second plurality of nanoparticles are formed of an anatase phase of titanium oxide.

20. The method of claim 15, wherein the first plurality of nanoparticles have a crystalline structure and the second plurality of nanoparticles have an amorphous structure.
